(19) United States
(12) Patent Application Publication
(10) Pub. No.: US 2026/0138476 A1
(43) Pub. Date: May 21, 2026

(54) METHOD FOR POSITIONING A VEHICLE

(71) Applicant: MAHLE International GmbH, Stuttgart (DE)

(72) Inventor: Mike Boettigheimer, Kornwestheim (DE)

(21) Appl. No.: 19/104,218

(22) PCT Filed: Aug. 16, 2023
(86) PCT No.: PCT/EP2023/072573

§ 371 Date: Feb. 5, 2026

(30) Foreign Application Priority Data
Aug. 16, 2022 (DE) 10 2022 120 699.8
Sep. 28, 2022 (DE) 10 2022 125 041.5

(51) Int. Cl. B60L 53/38; B60L 53/126

(52) U.S. Cl. CPC B60L 53/38; B60L 53/126

(57) ABSTRACT

A method for positioning a vehicle with a mobile inductive charging device in a defined position relative to a stationary inductive charging device, may include providing a positioning signal in one of the mobile inductive charging device and the stationary inductive charging device. The method may further include inducing, via the positioning signal, at least one voltage signal in the other of the mobile inductive charging device and the stationary inductive charging device. The method may also include approximating a relative distance between the mobile inductive charging device and the stationary inductive charging device from the at least one induced voltage signal.

### CROSS-REFERENCE TO RELATED APPLICATIONS

This application claims priority to International Patent Application No. PCT/EP2023/072573, filed on Aug. 16, 2023, German Patent Application No. DE 10 2022 125 041.5, filed on Sep. 28, 2022, and German Patent Application No. DE 10 2022 120 699.8, filed on Aug. 16, 2022, the contents of all of which are hereby incorporated by reference in their entirety.

### TECHNICAL FIELD

The invention relates to a method for positioning a vehicle according to the independent patent claim. The invention also relates to a graphical display element for a vehicle.

### BACKGROUND

U.S. Pat. No. 10,541,551B2 proposes to guide a vehicle to a location defined by an x- and a y-value by evaluating the magnitude of an induced voltage. However, the method involves a relatively complicated calculation.

### SUMMARY

The present invention is concerned with the task of specifying improved or at least alternative embodiments for a method of positioning a vehicle of the type mentioned at the beginning.

A method for positioning a vehicle with a mobile inductive charging device in a defined position relative to a stationary inductive charging device is proposed, wherein a positioning signal is generated in one of the two inductive charging devices and the positioning signal induces at least one voltage signal in the other of the two inductive charging devices and a relative distance between the mobile inductive charging device and the stationary inductive charging device is approximated from the induced voltage signal.

The term “inductive charging device” thus refers here only to one of at least two parts that are necessary for an induction charging process for energy transmission. During the induction charging process, an energy transmission winding generates an alternating magnetic field during the transmission of energy in an inductive charging device. This alternating magnetic field induces a voltage in a further energy transmission winding of a further inductive charging device. This additional inductive charging device thus serves as a counterpart for this specific charging process. The energy is transmitted wirelessly and absorbed by inducing a voltage.

A stationary inductive charging device is the non-mobile part of a vehicle charging system, i.e., the part that does not move with the vehicle.

A stationary inductive charging device can preferably be located on, at, or in a floor. This can be an inductive charging device mounted on the ground or an inductive charging device recessed into a floor or ground. A floor can be a roadway, a parking lot surface, a garage floor, a floor in a parking garage or any other building. Alternatively, a stationary inductive charging device can also be located on walls or similar.

A mobile inductive charging device can be arranged on and/or in a vehicle. Generally speaking, this refers to the part of a vehicle charging system that moves with the vehicle. An inductive charging device on and/or in the vehicle is therefore suitable for absorbing the magnetic field and providing electrical energy to a vehicle's energy storage device, for example a battery or an accumulator in the vehicle.

For efficient energy transmission, the mobile inductive charging device must be positioned as precisely as possible in relation to the stationary inductive charging device. The mobile inductive charging device must therefore be positioned in a defined position in relation to a stationary inductive charging device. The defined position is a predetermined position that is preferred to ensure that energy can be transmitted with the highest possible efficiency. In this case, it can be particularly taken into account that one energy transmission winding each is positioned in the two inductive charging devices with the smallest possible distance to each other and opposite each other with regard to an air gap between them. Since both energy transmission windings do not generally have to be the same size, symmetrical positioning, in which the winding axes of the two energy transmission windings are superimposed on top of each other as far as possible, is also advantageous here. Precise positioning is often difficult or impossible for the driver without additional support in the form of a driver assistance system.

A positioning signal can be an electromagnetic or magnetic alternating field that can induce a voltage signal in the other of the two inductive charging devices. It is possible that the positioning signal is transmitted or generated directly by an energy transmission winding of an inductive charging device, or that one or more additional windings or another signal-generating device is/are present for this purpose.

The positioning signal preferably transmits power that is significantly lower than the power transmitted during energy transmission.

When a positioning signal is generated in the stationary inductive charging device, it induces a voltage in the mobile inductive charging device. When a positioning signal is generated in the mobile inductive charging device, it induces a voltage in the stationary inductive charging device.

The respective inductive charging device may be a larger unit, with the components for energy transmission forming only part of the inductive charging device. The fact that a positioning signal is generated “in” an inductive charging device or that a voltage signal is generated “in” an inductive charging device means that this takes place within this larger unit.

During the positioning process, it is important for the driver of a vehicle to receive information about the relative distance to the target position. This allows them to adjust the speed gradually or prepare for braking.

A relative distance is a variable that changes continuously, preferably proportionally, with distance when the distance changes, but which does not necessarily provide information about the absolute distance in meters. During a positioning process, it is sufficient for a driver to receive information about the relative distance to the target position, for example via a graphical display element. Information about the absolute distance is not necessary here. While other relative methods are based on the comparison of several signals, the magnitude of an induced voltage is used to determine a relative distance. A relative distance is then approximated from the induced voltage. This means that the measured induced voltage is included in a calculation that is at least partially based on an approximation. This can be, for example, a polynomial approximation that approximates the nonlinear relationship between a voltage induced by an alternating magnetic field and the distance to the transmitter of the magnetic field. The approximate determination of the absolute distance in meters generally requires a complex calibration. The combination of an approximate calculation with only a relative determination of the distance is advantageous because it is an easy way to provide a driver with the necessary information without the need for extensive calibration.

Preferably, the mobile inductive charging device or the stationary inductive charging device has a first sensor winding and a second sensor winding, which are arranged symmetrically to the longitudinal direction of the vehicle or to the nominal longitudinal direction of the vehicle, and the positioning signal generates a first voltage signal in the first sensor winding and a second voltage signal in the second sensor winding, and an approximated relative distance value is determined from the sum of the two voltage signals, and a directional deviation value between the longitudinal direction of the vehicle and the nominal longitudinal direction of the vehicle is determined from the comparison of the two voltage signals.

The first and/or second sensor winding can be arranged in or on the mobile or stationary inductive charging device.

Generally speaking, a coil is defined here as a component for generating or receiving a magnetic field. A coil can consist of a winding and optional further elements such as a magnetic core and a coil former. A winding is a coiled arrangement of a conductor. A winding can consist of one or more turns, wherein a turn refers to a full revolution of a conductor. Generally speaking, a winding can also consist of less than one turn, for example 0.5 turns. Of course, an incomplete number of turns, such as 2.5 turns, is also possible.

A sensor winding according to the invention can be designed in different forms and can have half, one, or preferably several windings. A conductor of such a sensor winding can, for example, have a cross-sectional area between 0.01 mm² and 2 mm². A conductor may be implemented here as a strand, as a single conductor, or in another form, for example in the form of conductor tracks on printed circuit boards.

If the sensor windings are located in a mobile inductive charging device, they are aligned symmetrically to the longitudinal direction of the vehicle. When the sensor windings are in a stationary inductive charging device, they are aligned symmetrically to the nominal longitudinal direction of the vehicle.

A stationary inductive charging device has a nominal longitudinal direction of the vehicle. This is the direction in which the longitudinal direction of the vehicle should be after a successful positioning operation.

A symmetrical arrangement of the two sensor windings with respect to the longitudinal direction of the vehicle or the nominal longitudinal direction of the vehicle means that the angle between the first sensor winding and the longitudinal direction of the vehicle/nominal longitudinal direction of the vehicle is at least approximately equal to the angle between the second sensor winding and the longitudinal direction of the vehicle/nominal longitudinal direction of the vehicle, wherein the two sensor windings are arranged axially symmetrically mirrored to the longitudinal direction of the vehicle/nominal longitudinal direction of the vehicle. The symmetrical arrangement is advantageous because, in addition to the relative distance, a directional deviation can be determined by a simple comparison of the voltages induced in both sensor windings. The two sensor windings can, for example, be arranged at an angle of 45° to the longitudinal direction of the vehicle or to the nominal longitudinal direction of the vehicle. The positioning signal can be symmetrical to the longitudinal direction of the vehicle or to the nominal longitudinal direction of the vehicle. In particular, the positioning signal can have a main direction of the magnetic field in the longitudinal direction of the vehicle or in the nominal longitudinal direction of the vehicle.

The positioning signal is advantageously generated by a positioning signal winding with a winding axis in the longitudinal direction of the vehicle or the nominal longitudinal direction of the vehicle.

If the positioning signal winding is located in a mobile inductive charging device of a vehicle, the winding axis of the positioning signal winding is advantageously aligned in the longitudinal direction of the vehicle.

If the positioning signal winding is located in a stationary inductive charging device, the winding axis of the positioning signal winding is advantageously aligned in the nominal longitudinal direction of the vehicle.

This type of arrangement generates a magnetic field with the main direction of the magnetic field lines in the longitudinal direction of the vehicle or in the nominal longitudinal direction of the vehicle. This has the advantage that this version allows for a significantly greater range than would be possible with a positioning signal generated by an energy transmission winding with the same power or magnetic field strength. Furthermore, this orientation of the magnetic field is particularly well suited to enabling the simplest possible detection of a position deviation or angle deviation in the sensor windings.

The positioning signal winding can be designed as a solenoid coil, also known as a cylindrical coil.

The positioning signal winding is preferably designed such that it has a particularly large extension in the driving plane and perpendicular to the longitudinal direction of the vehicle or to the nominal longitudinal direction of the vehicle. For example, the positioning signal winding can extend across the entire width of an inductive charging device. Preferably, the positioning signal winding extends over at least 50% of the width of the energy transmission winding of the inductive charging device, and particularly preferably over at least 75% of the width of the energy transmission winding of the inductive charging device. In particular, the positioning signal winding may also extend across the entire width of the power transmission winding of the inductive charging device. This results in a largely homogeneous magnetic field with the main direction of the magnetic flux running in the longitudinal direction of the vehicle, i.e., in the nominal longitudinal direction of the vehicle, and local field increases are prevented or reduced.

The positioning signal is advantageously generated in the stationary inductive charging device and the voltage signal is induced in the mobile inductive charging device.

In principle, both inductive charging devices—both the stationary and the mobile inductive charging device—can be the inductive charging device in which the positioning signal is generated and the other of the two inductive charging devices is then the inductive charging device in which the positioning signal is preferably detected by detecting at least one induced voltage signal. However, it may be advantageous to choose the stationary inductive charging device as the inductive charging device in which the positioning signal is generated and thus the mobile inductive charging device as the inductive charging device in which the voltage signal is detected. With this arrangement, the sensor data with the information about directional deviations and relative distances are directly in the vehicle, which then also has to make the appropriate driving correction. If the sensors are located in the stationary inductive charging device, the corresponding information about a necessary travel correction must first be transmitted to the vehicle. This requires a separate data channel and can result in delays.

The approximation expediently includes a calculation of an approximated relative distance value from the sum of the voltage signals, wherein the calculation is subject to the condition that there is a non-linear relationship between the sum of the voltage signals and the distance value and that the distance value is smaller the greater the sum of the voltage signals.

While the voltage signals from the two sensor windings can be compared with each other to determine a directional deviation, they can be added to determine a relative distance. The further away the two sensor windings are from the transmitter of the positioning signal, the lower the total voltage induced in the two sensor windings, all other parameters being equal. The relationship between distance and induced voltage is non-linear.

According to a preferred embodiment, the approximated relative distance value is displayed graphically or acoustically in the vehicle.

The graphical or acoustic representation of the information about the relative distance to the target position can help the driver to adjust their speed accordingly and/or prepare for braking. This can be done acoustically, for example, as is already common practice in parking assistance systems. The information can also be presented in graphical form. A graphical representation in the form of a bar that decreases as the vehicle approaches the target position may be suitable.

The directional deviation value is displayed graphically in the vehicle as a matter of preference.

A directional deviation is particularly advantageous to indicate graphically, since a corresponding value is difficult to present acoustically—possibly even in addition to acoustic information about the relative distance. In this case, the directional deviation value can be realized, for example, in the form of an arrow pointing in the direction in which the driver has to steer the vehicle. A corresponding graphical representation can be advantageously realized with a graphical representation of the relative distance—for example, in the form of a bar that decreases in size.

Advantageously, a value is calculated from at least the number of turns of the positioning signal winding and the electrical current in the positioning signal winding, and the value is used in the approximation of the relative distance.

A positioning signal winding through which alternating current flows generates a magnetic flux. This magnetic flux depends, among other parameters, to a great extent on the number of turns of the positioning signal winding and on the electrical current strength. In particular, the effective value of the alternating electric current is relevant here. For the other parameters, the geometry of the positioning signal winding is particularly important. For a given frequency and a given distance, the induced voltage is proportional to the product of the number of turns and the current strength. A value, which is calculated at least from the number of turns of the positioning signal winding and the electrical current strength, thus in particular the product of the number of turns and the electrical current strength, can therefore be used for the approximation of the relative distance.

It is useful to convert the voltage signals into digital signals and process them in such a way that only the voltage signals in a certain frequency range are used to determine the sum and the comparison.

For conversion into digital voltage signals, the signals can be sampled in an analog-digital conversion unit. The digital voltage signals can then be transformed into the frequency range and filtered in a specific frequency range.

In a frequency transformation, a signal from the time domain is mathematically transformed into the frequency domain. For a time-dependent signal, an analysis in the frequency domain provides information on the strength of a particular frequency or a particular frequency range in this signal.

An analysis in the frequency domain is advantageous here, especially since it is thus possible to filter around the frequency or frequency range of the positioning signal and thus achieve a better signal-to-noise ratio and thus a greater range.

Alternatively, it may also be possible to evaluate the voltage signal in a certain frequency range or at a certain frequency without performing a mathematical transformation of the entire voltage signal.

It is advantageous if the signal transformed into the frequency domain is filtered by a filter with a bandwidth B around the excitation frequency. The positioning signal generated is produced at a specific excitation frequency. The excitation frequency can be in the range of 10 kHz to 150 kHz.

It is not necessary to evaluate the complete induced voltage signal in the entire frequency range; rather, it is sufficient to evaluate it near the excitation frequency. A digital filter can be used for this.

A digital filter is a mathematical function that is applied to the discrete signal in the frequency range. The discrete frequency values are thus limited to values in a specific preset frequency band with a bandwidth of B. For example, the bandwidth may be in the order of 1 kHz. The frequency band is selected such that it contains the excitation frequency, preferably such that it contains the excitation frequency in the center.

In a preferred variant, the calculation of the approximated relative distance value includes a polynomial, which is a polynomial of at least the third degree. The polynomial can, for example, have the following form:

$$f ( x ) = 0.0000159 {x}^{3} - 0.0116395 {x}^{2} + 2.9305376 x$$

Wherein x can be the measured induced voltage and f(x) is incorporated into the determination of the relative distance or it is this. A polynomial is an easy way to approximate the nonlinear dependence between the induced voltage and the distance.

In an alternative preferred embodiment, the calculation of the approximated relative distance value includes an exponential function.

The sum of the voltage signals is only evaluated favorably if it exceeds a start value and does not exceed a stop value. The method is advantageous for determining a relative distance in addition to determining a directional deviation, which is based on a comparison of two induced voltages. There may be a start value for a corresponding method. If the induced voltage is below this threshold, the signals are too weak to enable optimal evaluation. Furthermore, there may also be a stop value for the induced voltages. If the voltage exceeds this value, the method is no longer sufficiently accurate from this value onwards and the method is terminated. At short distances and thus high induced voltages, the magnetic field lines show stronger curvatures. Therefore, a corresponding determination of a directional deviation from a comparison of different induced voltages at different angles from the point at which the distance is exceeded and thus from the point at which a stop value for the induced voltages is exceeded can no longer be made, or at least it is more difficult to do so. From this stop value and thus from this distance, a supplementary close-range positioning system must then take over.

The invention further relates to a graphical display element for a vehicle with a mobile inductive charging device, wherein the graphical display element is suitable for displaying a relative distance between a mobile inductive charging device and a stationary inductive charging device as a relative distance indicator and wherein the relative distance is determined by means of a method according to the invention.

The graphical display element can be a display. The method according to the invention, together with the display element, represents a driver assistance system that supports a driver in precisely positioning a vehicle in a defined position in relation to a stationary inductive charging device. For example, a relative distance indicator can be implemented in the form of a bar that decreases as the distance to the target position decreases. It is also possible that the graphical display element additionally visually represents when the method according to the invention is terminated and an additional close-proximity positioning method is used.

In addition to the relative distance, a directional deviation can be displayed, for example. A directional deviation can be realized in the form of an indicator pointing in the direction in which the vehicle has to be steered.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, each schematically

FIG. 1 shows a highly simplified representation of a vehicle with an inductive charging device,

FIG. 2 shows a plan view of an inductive charging device with sensor windings,

FIGS. 3A and 3B show a schematic representation of a vehicle charging system during the positioning process,

FIG. 3A shows a vehicle with a longitudinal direction of the vehicle with a mobile inductive charging device during a positioning process over a stationary inductive charging device with a nominal longitudinal direction of the vehicle,

FIG. 3B shows an exemplary embodiment in which the positioning signal winding is arranged in the stationary inductive charging device and the sensor windings are arranged in the mobile inductive charging device,

FIG. 4A shows a graphical display element that indicates the directional deviation,

FIGS. 4B through 4E show four different displays of the relative distance during an approach process,

FIG. 5 shows a greatly simplified block diagram showing how the measured voltages are evaluated.

### DETAILED DESCRIPTION

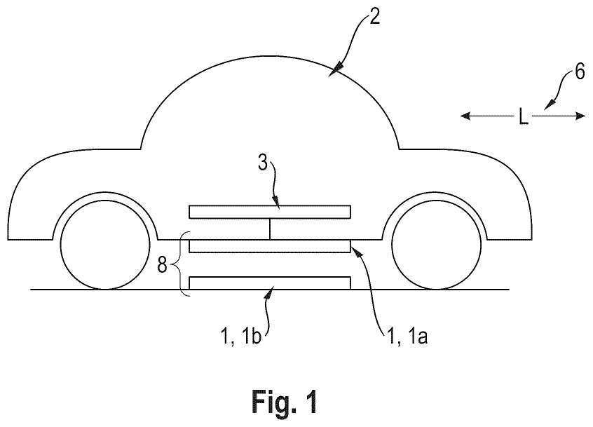

FIG. 1 shows a mobile inductive charging device Error! Reference source not found. REF Ref91061576 \r \h \*MERGEFORMAT Error! Reference source not found, which is arranged on a vehicle Error! Reference source not found. with a battery Error! Reference source not found. and positioned above a stationary inductive charging device Error! Reference source not found. Error! Reference source not found. During operation, energy can be transferred from the stationary inductive charging device Error! Reference source not found. to the mobile inductive charging device Error! Reference source not found. and the battery Error! Reference source not found. can be charged by this means. The mobile inductive charging device Error! Reference source not found. and the stationary inductive charging device Error! Reference source not found. together form or are part of the vehicle charging system Error! Reference source not found. In the process, energy can be temporarily transferred from the mobile inductive charging device Error! Reference source not found. to the stationary inductive charging device Error! Reference source not found.

The stationary inductive charging device Error! Reference source not found. a ranged on the ground in FIG. 1 can alternatively also be arranged recessed in the roadway (not shown here). In a recessed arrangement, the inductive charging device Error! Reference source not found. can be covered by certain layers of the road surface or be flush with the road surface.

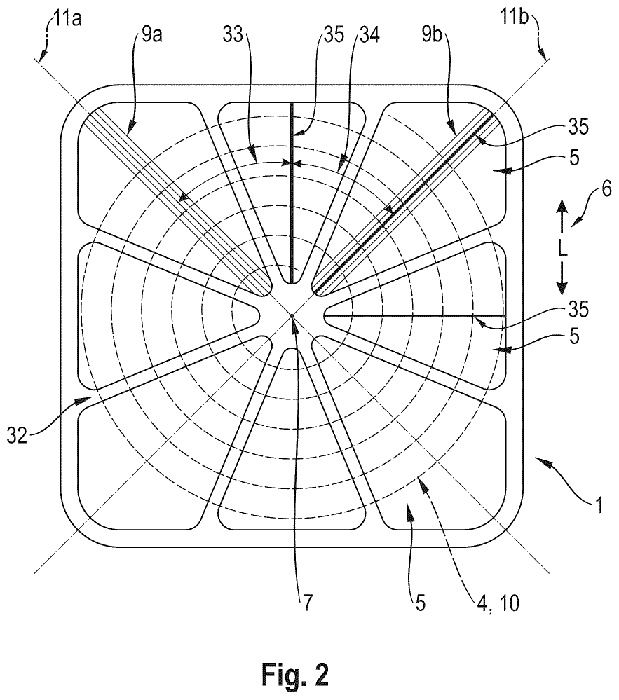

FIG. 2 shows a top view of an inductive charging device Error! Reference source not found. according to the invention. This may be a mobile inductive charging device Error! Reference source not found. or a stationary inductive charging device Error! Reference source not found. In the present exemplary embodiment, eight flux guiding elements Error! Reference source not found, are shown, which are arranged radially around the center Error! Reference source not found. of the energy transmission winding Error! Reference source not found. in the plane. The energy transmission winding Error! Reference source not found, which in this top view is located below the flux guiding elements Error! Reference source not found. is indicated by a dashed line. The energy transmission winding Error! Reference source not found. is a flat coil Error! Reference source not found. A first sensor winding Error! Reference source not found. is arranged around one of the flux guiding elements Error! Reference source not found, and a second sensor winding Error! Reference source not found. is arranged around another flux guiding element Error! Reference source not found. The sensor windings are designed as a solenoid coil here. The first sensor winding Error! Reference source not found. is arranged axially symmetrical to the second sensor winding Error! Reference source not found. with respect to the longitudinal direction of the vehicle Error! Reference source not found. The first sensor winding Error! Reference source not found. has a first radial longitudinal direction Error! Reference source not found. and the second sensor winding Error! Reference source not found. has a second radial longitudinal direction Error! Reference source not found. The angle Error! Reference source not found. between the first radial longitudinal direction Error! Reference source not found. and the longitudinal direction of the vehicle Error! Reference source not found. is at least approximately equal to the angle Error! Reference source not found. between the second radial longitudinal direction Error! Reference source not found. and the longitudinal direction of the vehicle. The first radial longitudinal direction Error! Reference source not found. and the second radial longitudinal direction Error! Reference source not found. intersect or cross each other at least approximately in the center Error! Reference source not found. of the energy transmission winding Error! Reference source not found. The first radial longitudinal direction Error! Reference source not found. and the second radial longitudinal direction Error! Reference source not found. extend radially outwards from the center Error! Reference source not found. of the energy transmission winding Error! Reference source not found. The two sensor windings Error! Reference source not found. Error! Reference source not found. are arranged symmetrically to the longitudinal direction of the vehicle Error! Reference source not found.

During the charging process, the vehicle Error! Reference source not found. is positioned above the stationary inductive charging device Error! Reference source not found. and energy is transferred to the mobile inductive charging device Error! Reference source not found. or from the mobile inductive charging device Error! Reference source not found. to the stationary inductive charging device Error! Reference source not found. The flux guiding elements Error! Reference source not found. assume the function of magnetic field guidance. When they are charged, the field lines of the magnetic field run approximately in a radial direction in them. Three magnetic field lines Error! Reference source not found. are indicated symbolically in FIG. 2. Since the first radial longitudinal direction Error! Reference source not found. and the second radial longitudinal direction Error! Reference source not found. are also aligned radially here and thus at least approximately parallel to the magnetic field lines Error! Reference source not found, only relatively little to no voltage is induced in the first sensor winding Error! Reference source not found. and in the second sensor winding Error! Reference source not found. This is important, as the sensor windings could easily be destroyed at the high power levels involved in energy transmission.

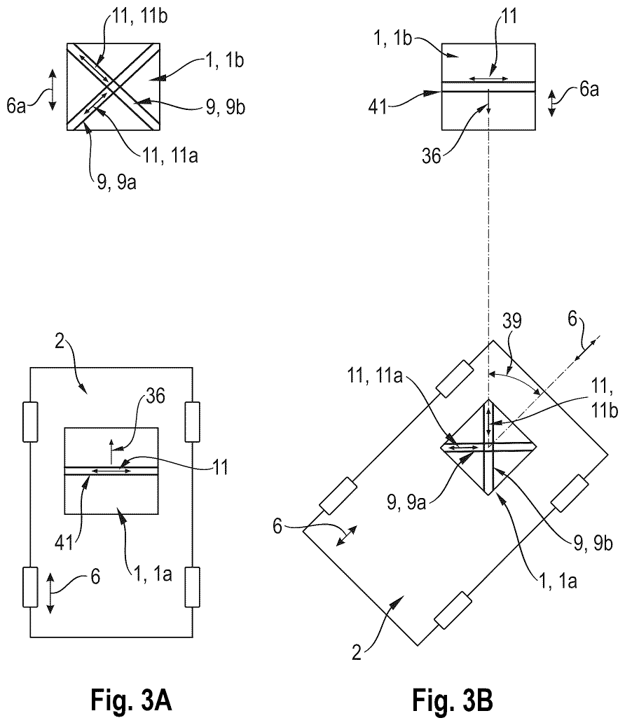

FIG. 3A shows a vehicle Error! Reference source not found. with a longitudinal direction of the vehicle Error! Reference source not found. with a mobile inductive charging device Error! Reference source not found. during a positioning process over a stationary inductive charging device Error! Reference source not found. with a nominal longitudinal direction of the vehicle Error! Reference source not found. The vehicle Error! Reference so urce not found. drives directly onto the stationary inductive charging device Error! Reference source not found. and the nominal longitudinal direction of the vehicle Error! Reference source not found. is thus equal to the longitudinal direction of the vehicle Error! Reference source not found. In the mobile inductive charging device Error! Reference source not found. in addition to the energy transmission winding (not shown), there is also a positioning signal winding Error! Reference source not found. The positioning signal winding Error! Reference source not found. has a winding axis Error! Reference source not found. and a radial longitudinal direction Error! Reference source not found. The stationary inductive charging device Error! Reference source not found. has two sensor windings Error! Reference source not found. and Error! Reference source not found. in addition to the energy transmission winding (not shown). In contrast to the design in FIG. 2, the two sensor windings 9a and 9b here have a greater extent and cross in the center of the inductive charging device 1. Both sensor windings 9a and 9b each have a radial longitudinal direction Error! Reference source not found. and Error! Reference source not found. Both sensor windings 9a and 9b are arranged symmetrically to the nominal longitudinal direction of the vehicle Error! Reference source not found. This arrangement of the windings for positioning is particularly advantageous. The positioning signal winding Error! Reference source not found. generates a positioning signal (not shown) which can induce a voltage in the sensor windings 9a and 9b. The positioning signal winding Error! Reference source not found. generates a fairly homogeneous magnetic field. A voltage is induced in the sensor windings Error! Reference source not found. and Error! Reference source not found. by the magnetic field of the positioning signal winding Error! Reference source not found. If the vehicle approaches the stationary inductive charging device Error! Reference source not found, exactly perpendicular, as shown in the left-hand sketch, an equal voltage is induced in both sensor windings Error! Reference source not found. and Error! Reference source not found.

FIG. 3B shows an exemplary embodiment in which the positioning signal winding Error! Reference source not found. is arranged in the stationary inductive charging device REF Ref91061744 \r \h \*MERGEFORMAT Error! Reference source not found. and the sensor windings Error! Reference source not found. and Error! Reference source not found. are arranged in the mobile inductive charging device Error! Reference source not found. Otherwise, this exemplary embodiment works in exactly the same way. The figure shows a case in which the vehicle Error! Reference source not found. does not approach the stationary inductive charging device Error! Reference source not found. perpendicularly, but deviates from it at an angle of approx. 45°. The longitudinal direction of the vehicle Error! Reference source not found. and the line connecting the stationary inductive charging device Error! Reference source not found. and the mobile inductive charging device Error! Reference source not found. are thus at a directional deviation angle Error! Reference source not found. of 45° to one another. In this case, the positioning signal winding Error! Reference source not found. generates a magnetic field that is perpendicular to the first sensor winding Error! Reference source not found. A maximum voltage is induced here. The magnetic field generated by the positioning signal winding Error! Reference source not found. is also approximately parallel to the second sensor winding Error! Reference source not found. Here, minimal or no voltage is induced.

In both exemplary embodiments, FIGS. 3A and 3B, a distance value from the target position can be approximated from the comparison of the voltages induced in the two sensor windings 9a and 9b, in addition to determining a directional deviation value by comparing the voltages induced in the two sensor windings 9a and 9b.

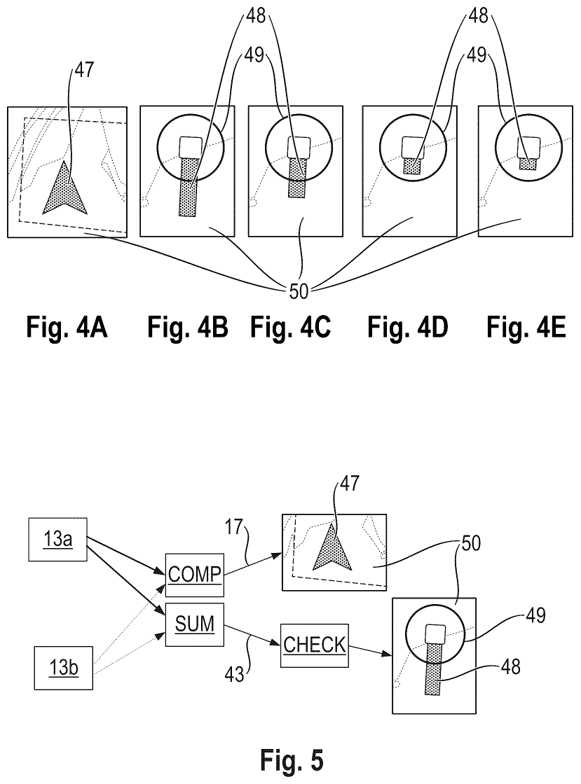

FIGS. 4A-4E shows a representation of a graphical display element Error! Reference source not found. that indicates the directional deviation (see, e.g., FIG. 4A) and the relative distance at four different distances (see, e.g., FIGS. 4B-4E). In FIG. 4A, an arrow can be seen as a directional deviation indicator Error! Reference source not found. on a graphical display element Error! Reference source not found. The graphical display element Error! Reference source not found. is located in a vehicle. FIGS. 4B through 4E show a relative distance indicator Error! Reference source not found. in the form of a bar in a graphical display element Error! Reference source not found. during an approach process. The bar in FIG. 4B through FIG. 4C and FIG. 4D through FIG. 4E is slowly reduced as the vehicle approaches its target position. The graphical display element Error! Reference source not found. also shows a close-up positioning circle Error! Reference source not found. As soon as the distance indicator Error! Reference source not found. in the form of a bar has decreased to such an extent that it is within the close-range positioning circle Error! Reference source not found, the positioning method that is evaluated changes. A so-called near-field positioning method is evaluated within the near-field positioning circle Error! Reference source not found. This provides direct information about the relative distance to the target position, but no longer a direct directional deviation value.

FIG. 5 shows a highly simplified block diagram for the evaluation of the measured voltages. The voltage signals Error! Reference source not found. Error! Reference source not found. received in the two sensor signal windings Error! Reference source not found. Error! Reference source not found. are both processed in a comparison unit COMP and in a summation unit SUM. The COMP comparison unit compares the two voltage signals Error! Reference source not found. Error! Reference source not found. with each other and determines a directional deviation value Error! Reference source not found. This directional deviation value is displayed in a graphical display element Error! Reference source not found. as a directional deviation indicator Error! Reference source not found. in the form of an arrow. The summation unit SUM adds the two voltage signals Error! Reference source not found. Error! Reference source not found. and the result Error! Reference source not found. is displayed in a graphical display element Error! Reference source not found. as a relative distance indicator Error! Reference source not found. in the form of a bar. A CHECK test unit checks whether the sum of the voltage signals Error! Reference source not found. Error! Reference source not found. is above a start value of the voltage signals Error! Reference source not found. and below a stop value of the voltage signals Error! Reference source not found. The result is only displayed in the graphical display element Error! Reference source not found, if both of these conditions are met. The graphical display element Error! Reference source not found. also contains a close-positioning circle Error! Reference source not found. If the sum of the voltage signals Error! Reference source not found. Error! Reference source not found. corresponds to the stop value of the voltage signals Error! Reference source not found, the graphical display element Error! Reference so urce not found. shows the relative distance indicator Error! Reference source not found. in the form of a bar exactly on the near positioning circle Error! Reference source not found. If the sum of the voltage signals Error! Reference source not found. Error! Reference so urce not found. is greater than the stop value of the voltage signals Error! Reference source not found, the positioning method according to the invention is no longer evaluated for the graphical display element Error! Reference source not found. Another close-range positioning method is now being evaluated and displayed on the graphical display element Error! Reference source not found.

1. A method for positioning a vehicle with a mobile inductive charging device in a defined position relative to a stationary inductive charging device, comprising:
providing a positioning signal in one of the mobile inductive charging device and the stationary inductive charging device;
inducing, via the positioning signal, at least one voltage signal in the other of the mobile inductive charging device and the stationary inductive charging devices; and
approximating a relative distance between the mobile inductive charging device and the stationary inductive charging device from the at least one induced voltage signal.

2. The method according to claim 1, wherein:
one of the mobile inductive charging device and the stationary inductive charging device includes a first sensor winding and a second sensor winding arranged symmetrically to a longitudinal direction of the vehicle or to a nominal longitudinal direction of the vehicle; and
the method further comprises:
providing, via the positioning signal, a first voltage signal in the first sensor winding and a second voltage signal in the second sensor winding;
determining an approximated relative distance value from a sum of the first voltage signal and the second voltage signal; and
determining a directional deviation value between the longitudinal direction of the vehicle and the nominal longitudinal direction of the vehicle from a comparison of the first voltage signal and the second voltage signals.

3. The method according to claim 1, wherein the positioning signal is provided via a positioning signal winding having a winding axis extending in a longitudinal direction of the vehicle or a nominal longitudinal direction of the vehicle.

4. The method according to claim 1, wherein the positioning signal is provided in the stationary inductive charging device and the at least one voltage signal is induced in the mobile inductive charging device.

5. The method according to claim 1, wherein:
the at least one voltage signal includes a plurality of voltage signals;
approximating the relative distance between the mobile inductive charging device and the stationary inductive charging device includes calculating an approximated relative distance value from a sum of the plurality of voltage signals;
a nonlinear relationship exists between the sum of the plurality of voltage signals and the approximated relative distance value; and
the approximated relative distance value is smaller the greater the sum of the plurality of voltage signals is.

6. The method according to claim 2, further comprising displaying the approximated relative distance value graphically and/or acoustically in the vehicle.

7. The method according to claim 2, further comprising displaying the directional deviation value graphically in the vehicle.

8. The method according to claim 3, further comprising calculating a value from at least a number of turns of the positioning signal winding and an electrical current strength in the positioning signal winding, wherein the value is used when approximating the relative distance between the mobile inductive charging device and the stationary inductive charging device.

9. The method according to claim 1, wherein the at least one voltage signal includes a plurality of voltage signals, and wherein the method further comprises:
determining an approximated relative distance value from a sum of at least some of the plurality of voltage signals;
determining a directional deviation value between a longitudinal direction of the vehicle and a nominal longitudinal direction of the vehicle from a comparison of at least some of the plurality of voltage signals;
converting the plurality of voltage signal into a plurality of digital signals; and
processing the plurality of digital signals such that only voltage signals of the plurality of voltage signals in a certain frequency range are used for determining the sum and the comparison.

10. The method according to claim 5, wherein calculating the approximated relative distance value includes a polynomial of at least the third degree.

11. The method according to claim 1, wherein the at least one voltage signal includes a plurality of voltage signals, and wherein the method further comprises:
determining a sum of the plurality of voltage signals; and
evaluating the sum of the plurality of voltage signals when the sum of the plurality of voltage signals exceeds a start value and does not exceed a stop value.

12. A graphical display element for a vehicle with a mobile inductive charging device, wherein the graphical display element is configured to display a relative distance between the mobile inductive charging device and a stationary inductive charging device as a relative distance indicator and the relative distance is determined via the method according to claim 1.

13. A method for positioning a vehicle with a mobile inductive charging device in a defined position relative to a stationary inductive charging device, comprising:
providing a positioning signal in a first inductive charging device;
inducing, via the positioning signal, a plurality of voltage signals in a second inductive charging device; and
approximating a relative distance between the first inductive charging device and the second inductive charging device from the plurality of induced voltage signals;
wherein the mobile inductive charging device is one of the first inductive charging device and the second inductive charging device, and the stationary inductive charging device is the other one of the first inductive charging device and the second inductive charging device.

14. The method according to claim 13, wherein inducing the plurality of voltage signals includes inducing a respective voltage signal in each of a plurality of sensor windings of the second inductive charging device.

15. The method according to claim 14, further comprising determining a sum of a group of voltage signals of the plurality of voltage signals, wherein each voltage signal of the group of voltage signals has a respective frequency that is within a certain frequency range.

16. The method according to claim 15, wherein approximating the relative distance includes determining an approximated relative distance value from the sum of the group of voltage signals.

17. The method according to claim 16, wherein a nonlinear relationship exists between the sum of the group of voltage signals and the approximated relative distance value.

18. The method according to claim 16, wherein an inverse relationship exists between the sum of the group of voltage signals and the approximated relative distance value.

19. The method according to claim 15, wherein approximating the relative distance includes determining a directional deviation value between a longitudinal direction of the vehicle and a nominal longitudinal direction of the vehicle via comparing the group of voltage signals.

20. The method according to claim 15, further comprising evaluating the sum of the group of voltage signals when the sum of the group of voltage signals exceeds a start value and does not exceed a stop value.
